(19) United States
(12) Patent Application Publication
(10) Pub. No.: US 2026/0109359 A1
(43) Pub. Date: Apr. 23, 2026

(54) SYSTEMS AND METHODS FOR PREDICTING DISSONANCE DURING SHARED CONTROL OF A VEHICLE

(71) Applicant: Toyota Research Institute, Inc., Los Altos, CA (US)

(72) Inventors: Emily Sarah Sumner, Cambridge, MA (US); Jonathan A. DeCastro, Arlington, MA (US); Guy Rosman, Cambridge, MA (US); Deepak Edakkattil Gopinath, Washington, DC (US); Andrew Michael Silva, Cambridge, MA (US); Thomas M. Balch, Damariscotta, ME (US); Xiongyi Cui, Somerville, MA (US); Xinyue Hu, Irvine, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 18/923,840

(22) Filed: Oct. 23, 2024

(51) Int. Cl. B60W 50/00; B60W 10/18; B60W 10/20; B60W 60/00

(52) U.S. Cl. CPC B60W 50/0097; B60W 10/18; B60W 10/20; B60W 60/0051; B60W 2540/30

(57) ABSTRACT

Systems, methods, and other embodiments described herein relate to detecting dissonance by an operator using a learning model during shared control involving a driving scenario from an operator preference and cue for adapting a driving model. In one embodiment, a method includes detecting characteristics about a driving scenario and an operator from acquired sensor data and an operator factor. The method also includes predicting dissonance for an automated takeover using a learning model with the characteristics, a driving command, and a cue about the operator. The method also includes adapting a shared-driving model (SDM) associated with a vehicle during a maneuver using the dissonance.

### TECHNICAL FIELD

The subject matter described herein relates, in general, to predicting dissonance during shared driving, and, more particularly, to detecting dissonance by an operator using a learning model during shared control between a vehicle and the operator from driving and operator data.

### BACKGROUND

Vehicles equipped with sensors generate data that facilitate perceiving other vehicles, obstacles, pedestrians, etc., of a surrounding environment for automated driving systems (ADS) and other downstream tasks. For example, a vehicle with a light detection and ranging (LIDAR) sensor uses light to scan the surrounding environment, while logic associated with the LIDAR sensor analyzes acquired data to detect object presence and other features of the surrounding environment. In further examples, cameras acquire image information about the surrounding environment from which a system derives awareness about aspects of the surrounding environment. This sensor data improves perceptions of the surrounding environment so that systems such as the ADS can accurately plan and navigate accordingly.

Operators driving while an ADS is active can benefit from increased safety and convenience. However, an operator can mistrust ADS control upon encountering errors over time that impacts ADS effectiveness, traffic safety, and system adoption. For example, an operator disengages the ADS as confidence drops when experiencing automated maneuvers that are abrupt, atypical, etc. Mistrust can also increase operator stress with ADS assistance leading to inconsistent driving behavior that decreases road safety for other vehicles and pedestrians. Accordingly, mistrust from an operator when driving with ADS commands reduces usage, thereby sacrificing safety.

### SUMMARY

In one embodiment, example systems and methods relate to detecting dissonance by an operator using a learning model during shared control involving a driving scenario from an operator preference and cue for adapting a driving model. Mistrust rates with shared control (e.g., automated driving, model predictive control (MPC), etc.) are increasing with certain systems. For example, reports have indicated that a majority of vehicle operators are fearful when an automated driving system (ADS) commands a vehicle. This can lead to a vehicle operator overly interfering during an automated maneuver that reduces system optimization and increases driving discomfort. A manual takeover and control by the vehicle operator after an automated maneuver can also reduce safety from disengaging beneficial features of the ADS over manual driving. For instance, an ADS keeps a vehicle in a lane when driving on a highway using shared control more relibley than manual operation during distracted driving. As such, systems that can foster trust increase adoption and wide-scale acceptance of an ADS for improving safety and comfort.

Therefore, in one embodiment, a prediction system assists a vehicle and an operator with sharing driving while maintaining operator intent through detecting dissonance for adapting a driving model. Here, dissonance can be the operator mistrusting, distrusting, etc., a driving command (e.g., a steering command) outputted by the driving model (e.g., a shared-driving model) during a driving scenario. The prediction system can automatically detect the dissonance using a learning model through observing when operator intent goes against the suggested action of the ADS, thereby avoiding explicit operator input. In one approach, the learning model infers the dissonance using the driving command, sensor data, and a cue about the operator. A decision result from the learning can indicate events where the operator increasingly controls the vehicle from the dissonance. Otherwise, the decision result indicates an automated takeover by the driving model and the operator allowing the driving command to execute.

In various implementations, the prediction system adjusts the driving model using the decision result and dissonance scores outputted by the learning model. In this way, the prediction system can increase trust with driving commands and prevent additional dissonance through factoring operator preferences. Accordingly, the prediction system improves the adoption of control by a driving model during a driving scenario through detecting dissonance using a learning model and adapting the driving model with data about the dissonance, thereby improving comfort and safety.

In one embodiment, a prediction system for detecting dissonance by an operator using a learning model during shared control involving a driving scenario from an operator preference and cue for adapting a driving model is disclosed. The prediction system includes a memory having instructions that, when executed by a processor, cause the processor to detect characteristics about a driving scenario and an operator from acquired sensor data and an operator factor. The instructions also include instructions to predict dissonance for an automated takeover using a learning model with the characteristics, a driving command, and a cue about the operator. The instructions also include instructions to adapt a shared-driving model (SDM) associated with a vehicle during a maneuver using the dissonance.

In one embodiment, a non-transitory computer-readable medium for detecting dissonance by an operator using a learning model during shared control involving a driving scenario from an operator preference and cue for adapting a driving model and including instructions that when executed by a processor cause the processor to perform one or more functions is disclosed. The instructions include instructions to detect characteristics about a driving scenario and an operator from acquired sensor data and an operator factor. The instructions also include instructions to predict dissonance for an automated takeover using a learning model with the characteristics, a driving command, and a cue about the operator. The instructions also include instructions to adapt a SDM associated with a vehicle during a maneuver using the dissonance.

In one embodiment, a method for detecting dissonance by an operator using a learning model during shared control involving a driving scenario from an operator preference and cue for adapting a driving model is disclosed. In one embodiment, the method includes detecting characteristics about a driving scenario and an operator from acquired sensor data and an operator factor. The method also includes predicting dissonance for an automated takeover using a learning model with the characteristics, a driving command, and a cue about the operator. The method also includes adapting a SDM associated with a vehicle during a maneuver using the dissonance.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a prediction system that is associated with assisting a vehicle and an operator with sharing control while maintaining operator intent through detecting dissonance.

FIGS. 3A and 3B illustrate embodiments of training the prediction system to infer and prevent dissonance and implementing the prediction system during a driving scenario.

FIG. 4 illustrates one embodiment of a method that is associated with predicting dissonance for an automated takeover using a learning model and adapting a driving model using the dissonance.

### DETAILED DESCRIPTION

Systems, methods, and other embodiments associated with detecting dissonance by an operator during shared control using a learning model from an operator preference and a cue for adapting a driving model are disclosed herein. In various implementations, operators frequently disagree with driving commands of a vehicle during shared control that causes uneasiness. This can lead to systems requesting that operators manually control the vehicle at least in-part, thereby reducing the benefits of shared control. A driving model may include a planner for shared control having analytical models of a difference between operator control for various trajectories. For example, a system implementing envelop control during driving factors steering differences involving shared control. However, driving and learning models that maintain trust in general robotics during control encounter difficulties adapting physical steering and modeling operator preferences.

Therefore, in one embodiment, a prediction system estimates dissonance for a takeover during shared control using a learning model that factors detected characteristics, a driving command, and an operator cue and adapts a driving model from the dissonance. Here, the detected characteristics may describe details about a driving scenario (e.g., crossing an intersection) and an operator and include an operator factor, such as a preferred cruising speed. The driving model (e.g., a shared-driving model) may derive the cue (e.g., a physical cue, a verbal cue, etc.) using sensor data associated with the driving command during the driving scenario. The driving and learning models can identify potential dissonance early through warning signs within the characteristics and the cue and intervene before facing uneasiness from the driving command, thereby improving trust for the shared control.

In one approach, the driving model receives a dissonance score from the learning model for adjusting parameters. The prediction system also processes outputs from the learning model to indicate a dissonance decision between the operator primarily controlling the vehicle and automated takeover by the driving model. Furthermore, the driving model learns operator preferences of the operator and proactively adapts for a maneuver during shared control using the dissonance score and decision. In this way, the system improves shared control by conforming to operator preferences and increases safety by reducing operator control.

In various implementations, the prediction system trains the driving and learning models through various loss computations. For instance, the learning model trains using a supervised loss involving dissonance estimates made from detected characteristics, the driving command, the operator cue, and dissonance associated with a maneuver (e.g., a simulated maneuver). Furthermore, the driving model trains using an automation loss derived from the characteristics, the operator cue, and a dissonance score outputted from the learning model upon training. Accordingly, the prediction system trains the learning model and the driving model for improving the adoption of shared control during a driving scenario through detecting dissonance and adapting the driving model using the dissonance.

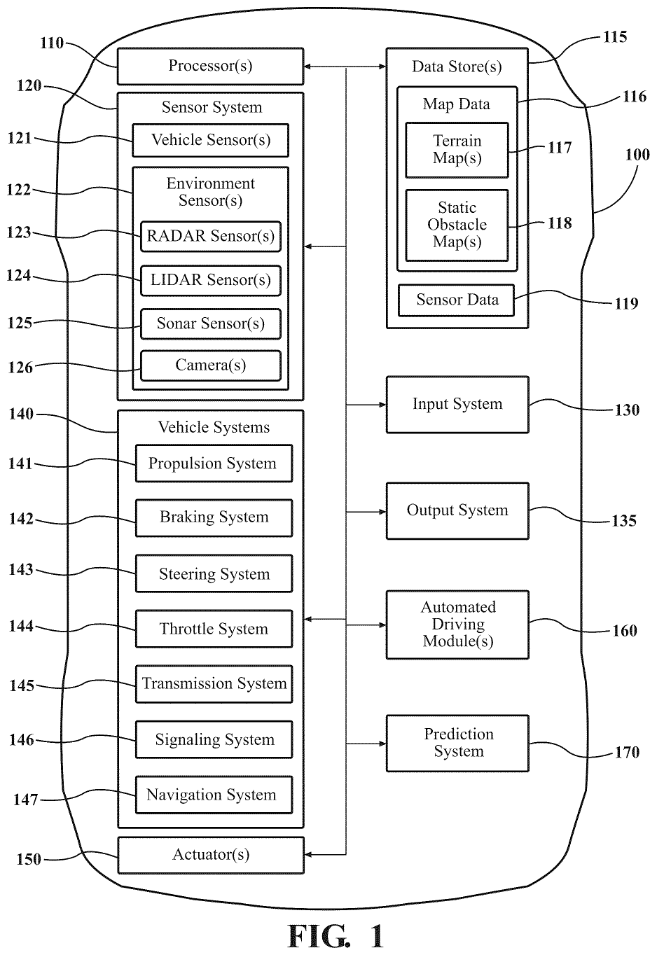

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, a prediction system 170 uses road-side units (RSU), consumer electronics (CE), mobile devices, robots, drones, and so on that benefit from the functionality discussed herein associated with detecting dissonance by an operator using a learning model during shared control from an operator preference and cue and adapting a driving model.

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances. For example, as discussed, one or more components of the disclosed system can be implemented within a vehicle while further components of the system are implemented within a cloud-computing environment or other system that is remote from the vehicle 100.

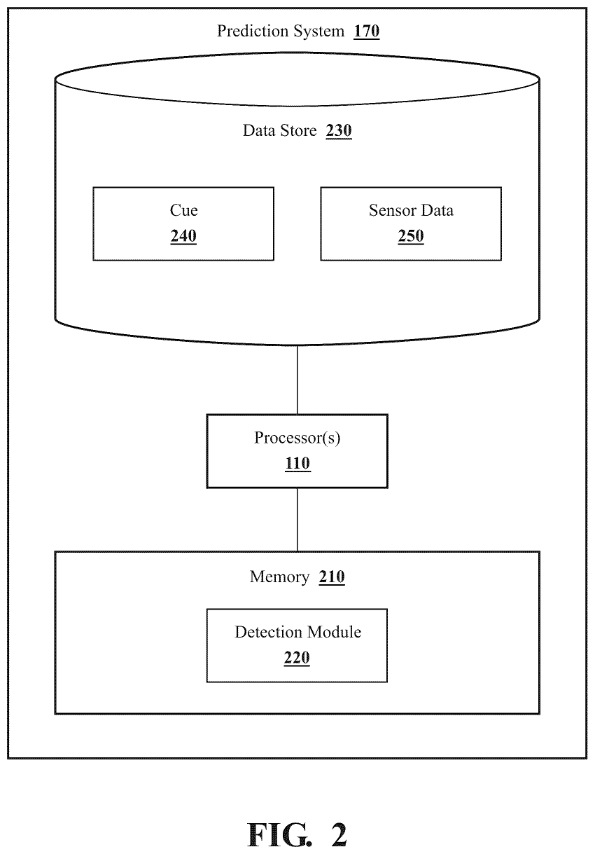

Some of the possible elements of the vehicle 100 are shown in FIG. 1 and will be described along with subsequent figures. However, a description of many of the elements in FIG. 1 will be provided after the discussion of FIGS. 2-4 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes a prediction system 170 that is implemented to perform methods and other functions as disclosed herein relating to detecting dissonance by an operator using a learning model during shared control from an operator preference and a cue for adapting a driving model.

With reference to FIG. 2, one embodiment of the prediction system 170 of FIG. 1 is further illustrated. The prediction system 170 is shown as including a processor(s) 110 from the vehicle 100 of FIG. 1. Accordingly, the processor(s) 110 may be a part of the prediction system 170, the prediction system 170 may include a separate processor from the processor(s) 110 of the vehicle 100, or the prediction system 170 may access the processor(s) 110 through a data bus or another communication path. In one embodiment, the prediction system 170 includes a memory 210 that stores a detection module 220. The memory 210 is a random-access memory (RAM), a read-only memory (ROM), a hard-disk drive, a flash memory, or other suitable memory for storing the detection module 220. The detection module 220 is, for example, computer-readable instructions that when executed by the processor(s) 110 cause the processor(s) 110 to perform the various functions disclosed herein.

The prediction system 170 as illustrated in FIG. 2 is generally an abstracted form of the prediction system 170. Furthermore, the prediction system 170 and/or the detection module 220 generally includes instructions that function to control the processor(s) 110 to receive data inputs from one or more sensors of the vehicle 100. The inputs are, in one embodiment, observations of one or more objects in an environment proximate to the vehicle 100 and/or other aspects about the surroundings. As provided for herein, the prediction system 170 and/or the detection module 220, in one embodiment, acquires sensor data 250 that includes at least camera images. In further arrangements, the prediction system 170 and/or the detection module 220 acquire the sensor data 250 from further sensors such as radar sensors 123, LIDAR sensors 124, and other sensors as may be suitable for identifying vehicles and locations of the vehicles.

Accordingly, the prediction system 170 and/or the detection module 220, in one embodiment, control the respective sensors to provide the data inputs in the form of the sensor data 250. Additionally, while the prediction system 170 and/or the detection module 220 are discussed as controlling the various sensors to provide the sensor data 250, in one or more embodiments, the prediction system 170 and/or the detection module 220 can employ other techniques to acquire the sensor data 250 that are either active or passive. For example, the detection module 220 passively sniffs the sensor data 250 from a stream of electronic information provided by the various sensors to further components within the vehicle 100. Moreover, the prediction system 170 and/or the detection module 220 can undertake various approaches to fuse data from multiple sensors when providing the sensor data 250 and/or from sensor data acquired over a wireless communication link. Thus, the sensor data 250, in one embodiment, represents a combination of perceptions acquired from multiple sensors.

Moreover, in one embodiment, the prediction system 170 includes a data store 230. In one embodiment, the data store 230 is a database. The database is, in one embodiment, an electronic data structure stored in the memory 210 or another data store and that is configured with routines that can be executed by the processor(s) 110 for analyzing stored data, providing stored data, organizing stored data, and so on. Thus, in one embodiment, the data store 230 stores data used by the detection module 220 in executing various functions. In one embodiment, the data store 230 includes the sensor data 250 along with, for example, metadata that characterize various aspects of the sensor data 250. For example, the metadata can include location coordinates (e.g., longitude and latitude), relative map coordinates or tile identifiers, time/date stamps from when the separate sensor data 250 was generated, and so on. In one embodiment, the data store 230 further includes cue 240 detailing one of a physical cue and a verbal cue associated with the operator. For example, the prediction system 170 derives the physical cue by measuring one of a pulse, a body position, posture, and eye movement from the operator during a driving scenario, following a driving command, etc. The driving scenario can be passing a vehicle on a highway, crossing an intersection, merging on a highway, parking, etc., or any maneuver that involves shared control during driving. The verbal cue can involve identifying one of a verbal tone and a keyword from the operator during the driving scenario following an automated maneuver, a driving command, etc. As further explained below, the prediction system 170 can identify and prevent dissonance from a driving model and a learning model using the cue 240.

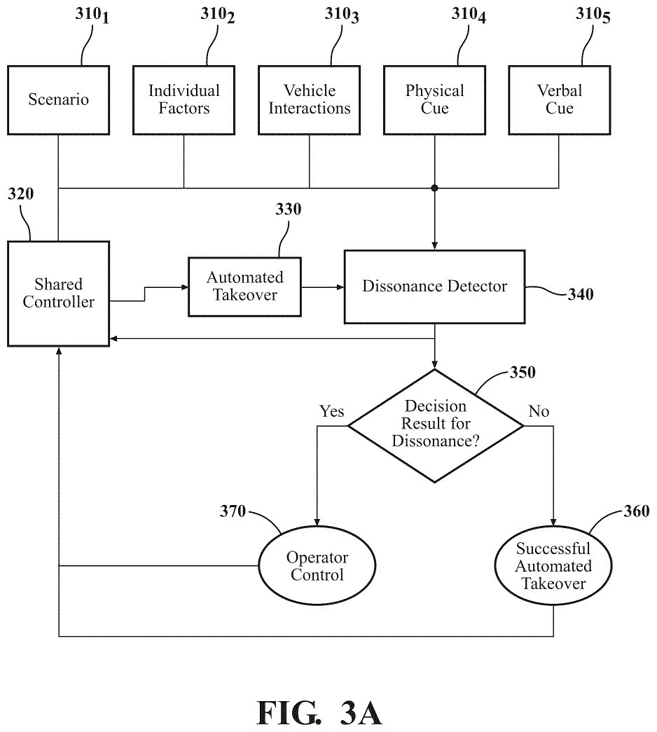

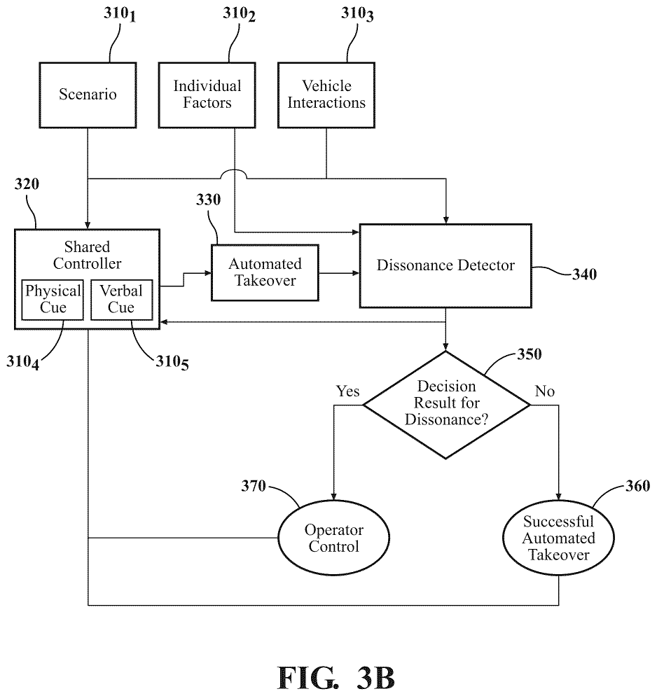

Turning to FIGS. 3A and 3B, embodiments of training the prediction system 170 to infer and prevent dissonance and implementing the prediction system 170 during a driving scenario involving shared control are illustrated. Here, the prediction system 170 can include dissonance detector 340 for predicting when an operator may disagree with actions by the vehicle 100 and sense actual disagreement and driving preferences during shared control. In one embodiment, the detection module 220 includes instructions that cause the processor 110 to detect characteristics about the driving scenario and an operator from acquired sensor data 250 and an operator factor. For instance, the characteristics are associated with shared control where both an operator and a driving model jointly manage vehicle operations to enhance safety and performance. Assistance examples during shared can include tasks such as lane keeping, adaptive cruise control, emergency braking, etc., where the operator is engaged and responsible for the vehicle 100 operation. In one approach, the automated driving module(s) 160 monitors driving conditions and operator commands and intervenes to prevent dangerous scenarios (e.g., an accident, collision, etc.). As such, shared control combines operator decisions with machine precision for creating safer and more efficient driving.

In another approach, the detected characteristics include an operator factor and describe details about a driving scenario (e.g., crossing an intersection). Here, the operator factor can indicate one of a state level for the driving scenario, driving preferences (e.g., cruising speed) associated with the driving scenario, and driver intent associated with a maneuver. Additionally, the state level may be associated with passing another vehicle traveling too slow or fast as the driving scenario, driving preferences (e.g., cruising speed, lateral control, etc.) associated with the driving scenario, and driver intent (e.g., pass, stay behind, etc.) associated with a maneuver. Furthermore, the prediction system 170 can predict dissonance for an automated takeover 330 using a learning model with the characteristics, a driving command outputted by the driving model, and the cue 240 about the operator. For example, the cue 240 describes physical motion (e.g., a sudden jerk) by the operator towards an automated maneuver that indicates stress, discomfort, etc. The dissonance can indicate that the operator will one of disagree with the driving command and counter the driving command. For instance, countering the driving command can include a steering command, a braking command, a throttle command, etc., that changes a path of the vehicle 100 initiated by an automated maneuver.

Moreover, in one approach, the prediction system 170 adapts the driving model associated with the vehicle 100 during a maneuver using dissonance information outputted by the dissonance detector 340. Shared controller 320 can include the driving model functioning as one of a shared-driving model (SDM), a model prediction control (MPC) system, a data-driven system that is trained, an automated driving system (ADS), and a shared-decision making model.

In FIG. 3A, the prediction system 170 can train the dissonance detector 340 having the learning model to score and identify dissonance using inputs 310₁-310₅ and automated takeover 330. In one embodiment, the learning model is a neural network (NN), such as a convolutional neural network (CNN), that performs semantic segmentation over the cue 240 and/or sensor data 250 from which further information is derived. Of course, in further aspects, the learning model may employ different machine learning algorithms or implements different approaches for performing the associated functions, which can include deep convolutional encoder-decoder architectures, or another suitable approach that generates semantic labels for the separate object classes represented in the image. Whichever particular approach the learning model implements, the learning model can output semantic labels identifying objects represented in the sensor data 250.

Regarding inputs, the scenario 310₁ can include scenario-specific information about a driving scenario derived from the sensor data 250. The driving scenario can be passing a vehicle on a highway, crossing an intersection, merging on a highway, parking, etc., or any maneuver that involves shared control, sharing driving, etc. As such, the scenario 310₁ can be objects at an intersection, agents around the vehicle 100 during a highway merge, weather conditions, scene information, etc. Operator factors can include the individual factors 310₂ and the vehicle interactions 310₃. The individual factors 310₂ can include information from a driving behavior questionnaire (dbq), driving preferences inputted by the operator (e.g., maximum speed, following distance, etc.). In one approach, the detection module 220 derives executive function capabilities about the operator for the individual factors 310₂ through a cognitive test about the driving scenario. For example, the cognitive test is text-based and administered to a test driver during training that gauges reflexes, reasoning abilities, etc., during the driving scenario. Similarly, the cognitive test can be questions and answers that are text-based, audible, etc., given by the prediction system 170 during inference. In one approach, the prediction system 170 administers the cognitive test in-part, completely, etc., when the vehicle 100 is stopped at a traffic light, stopped, etc., for gaining further intelligence about dissonance while maintaining safety. In this way, the cognitive test can indicate a cognitive load during the driving scenario, events that overwhelm the operator during shared control, etc., and prevent dissonance accordingly.

Moreover, the vehicle interactions 310₃ include one of steering, braking, and throttle information by the operator about the driving scenario. For example, the detection module 220 derives the vehicle interactions 310₃ from the sensor data 250. In another approach, the prediction system 170 acquires the vehicle interactions 310₃ from one or more vehicle systems 140. Thus, the vehicle interactions 310₃ can be data associated with individual traits that the operator feels about the driving scenario.

During training, the detection module 220 can derive the physical cue 310₄ and the verbal cue 310₅ using various approaches. For example, the detection module 220 measures one of a pulse, a heart rate, and eye movement during the driving scenario as the physical cue 310₄. Eye movement can involve using images captured by an in-cabin camera from one or more cameras 126 to track vision from the operator. This can involve identifying when the operator is focusing on a road object, the percentage time looking away from a road, hyperfocusing on a road object, etc. Furthermore, the detection module 220 can identify one of a verbal tone and a keyword from the operator during the driving scenario using the sensor data 250 as the verbal cue 310₅.

Training the prediction system 170 can involve the following details and approaches. The inputs 310₁-310₅ provide insight to an operator liking the driving command, automated takeover 330, etc., by the shared controller 320 that the operator anticipates the vehicle 100 will execute or execute shortly. Here, the automated takeover 330 can include driving commands for the vehicle 100 to execute associated with a maneuver. For instance, an operator exhibits an elevated heart rate when fear increases, voice tones change, etc., during the maneuver. As such, the prediction system 170 trains to observe the operator for an early cue, such as slight changes in the physical cue 310₄ along with realized actions including opposing controls (e.g., steering, braking, etc.). In this way, the prediction system 170 can utilize the realized cue to learn preferences and the early cue to anticipate dissonance by adapting behaviors of the shared controller 320 and the vehicle 100 in real-time.

Moreover, in one embodiment, a driving model associated with the shared controller 320 receives the inputs 310₁-310₅, a score associated with dissonance from the dissonance detector 340, and a decision result 350 associated with dissonance. The score of the dissonance can be a numeric value (e.g., 1-10), a numeric value including qualitative metrics such as confidence, etc. In one approach, the score indicates a degree of the dissonance. The decision result 350 may indicate one of the operator controlling the vehicle 100 rather than allowing a maneuver involving automated control (e.g., an automated lane change) and the automated takeover of the vehicle 100 by the driving model. In one approach, the operator control involves primarily driving the vehicle 100 without a manual takeover, thereby allowing the driving model to still assist the operator during the driving scenario, an upcoming driving scenario, after the driving scenario, etc.

In one approach, the output of the shared controller 320 is the automated takeover 330 that includes driving commands recommended for the vehicle 100 to automatically execute a maneuver involving minimal operator commands. For instance, the vehicle 100 attempts to automatically pass another vehicle on a highway by moving into the left lane from the right lane and accelerating. In another approach, the shared controller 320 outputs a driving command from an MPC derived using operator and motion constraints involving the inputs 310₁-310₅. For instance, the MPC implements a mathematical model (e.g., a bicycle model) to predict and optimize future behavior of the vehicle 100 and adjusts control inputs in real-time to meet performance metrics.

The prediction system 170 can compute losses using estimates fed back from the dissonance detector 340 made with the inputs 310₁-310₅ and outputs from the shared controller 320 associated with the driving scenario. The dissonance detector 340 can use the losses to improve predictions through training. In one approach, a supervised loss that is computed trains the learning model utilized by the dissonance detector 340 using characteristics about the driving scenario, the driving command from the shared controller 320, the cue 240 derived from the sensor data 250, and driving data (e.g., fleet data) about maneuvering a road. The driving scenario can be passing a vehicle on a highway, crossing an intersection, merging on a highway, parking, etc., or any maneuver that involves shared control. Here, human feedback may indicate whether the human experienced dissonance during a maneuver involving the driving scenario that is compared with the decision result 350 derived with outputs from the dissonance detector 340. For example, a supervised loss is elevated when the decision result 350 indicates dissonance contrary to an actual reaction for the driving scenario derived using a questionnaire. However, the supervised loss is minimal when a decision result is similar to the actual reaction involving an output from the shared controller 320.

Another training operation can involve the prediction system 170 calculating an automation loss for training the shared controller 320 using the characteristics, the cue 240, and a score of the dissonance outputted from the learning model. Here, the training can involve adjusting weights of the shared controller 320 using the calculated automation loss through a feedback loop when the score for dissonance is elevated. An elevated score can indicate manual control by the operator during shared control of the vehicle 100. An elevated score can also indicate manual takeover by the operator that involves disengaging automated driving module(s) 160. In one approach, the score is derived with a human annotating a maneuver(s) from the automated takeover 330 and the inputs 310₁-310₅ for dissonance. In another approach, a trained classifier indicates features about the maneuver(s) from the automated takeover 330 and the inputs 310₁-310₅ for dissonance. As such, the prediction system 170 reducing the automation loss for the shared controller 320 through training can increase maintaining automated control through decreasing dissonance.

Now turning to FIG. 3B, the prediction system 170 detecting and mitigating dissonance during inference for the vehicle 100 is illustrated. Here, the decision result 350 may indicate one of the operator controlling the vehicle 100 rather than allowing a maneuver involving automated control (e.g., an automated lane change) and the automated takeover of the vehicle 100 by the driving model during inference. The vehicle 100 can execute the automated takeover 330 when the decision result 350 indicates no, limited, etc., dissonance by the operator. Otherwise, the shared control involves the operator control 370 to avoid manual takeover upon detecting dissonance. This can involve the operator primarily controlling the vehicle 100 while keeping shared control active, thereby avoiding complete manual control.

In various implementations, inference operation involves acquiring and feeding inputs 310₁ and 310₃ to the shared controller 320 in real-time. Here, the prediction system 170 can derive characteristics about the driving scenario from the inputs 310₁ and 310₃. An example is identifying hazards when automatically maneuvering the vehicle 100 through a particular intersection at night. However, the individual factors 310₂ are fed to the dissonance detector 340 rather than the shared controller 320 that is unnecessary during inference unlike training. Inference operation also involves the physical cue 310₄ and the verbal cue 310₅ being produced by the shared controller 320 rather than being independently acquired from a training dataset that may be unavailable during inference. This can also allow cue representation that is accurate through the shared controller 320 directly observing operator reactions and driving features that are subtle directly during shared control of the vehicle 100.

In one approach, the shared controller 320 derives the physical cue 310₄ and the verbal cue 310₅ in-part from the sensor data 250. Such information can involve the operator exhibiting an elevated heart rate when fear increases, emotion changes, voice tones change, etc. For instance, the information includes eye movement from images captured by an in-cabin camera to track vision from the operator associated with focusing on a road object, percentage time looking away from a road, hyperfocusing on the road object, etc. The prediction system 170 can use the information as early indicators to estimate dissonance and increase confidence when combined with the vehicle interactions 310₃. In this way, the outputs of the shared controller 320 can include parameters describing the automated takeover 330, the physical cue 310₄, and the verbal cue 310₅ that the dissonance detector 340 can process to estimate and anticipate dissonance.

In various implementations, the dissonance detector 340 includes a learning model that predicts whether the operator would experience dissonance through factoring the parameters about the automated takeover 330 and the inputs 310₁-310₅ during inference. This allows the prediction system 170 to accurately infer dissonance using operator factors (e.g., preference, intent, etc.) along with automated tendencies, such as driving commands outputted by the automated driving module(s) 160. Furthermore, the prediction system 170 can adapt future behavior of the shared controller 320 using a score outputted by the dissonance detector 340, the operator control 370, and successful automated takeover 360. The score of the dissonance can be a numeric value (e.g., 1-10), and include qualitative metrics such as confidence, trust, etc. For example, the score indicates a degree of the dissonance. As such, the prediction system 170 can adjust hyperparameters during inference for an ADS that is data-driven that is part of the shared controller 320, thereby improving performance through reducing dissonance. For other implementations, in one approach, a MPC adjusts parameters and weights in real-time using computations from cost, loss, etc., functions through factoring a dissonance score, the operator control 370, and successful automated takeover 360 associated with the automated takeover 330.

Moreover, adaptation for shared control of the vehicle 100 can involve modifying speeds, turn rates, etc., of maneuvers for improving shared control along with reducing instances of the operator control 370. In one approach, adaptation influences changing hyperparameters, parameters, etc., influencing decisions for trajectory generation and path planning by the shared controller 320. For instance, the shared controller 320 uses a score from the dissonance detector 340 to decide when the cue 240 is correlated with dissonance, a takeover strategy, etc., that maximizes performance and safety. Accordingly, the prediction system 170 leverages a realized cue to learn preferences and anticipate dissonance early and adapt automated behaviors of the vehicle 100.

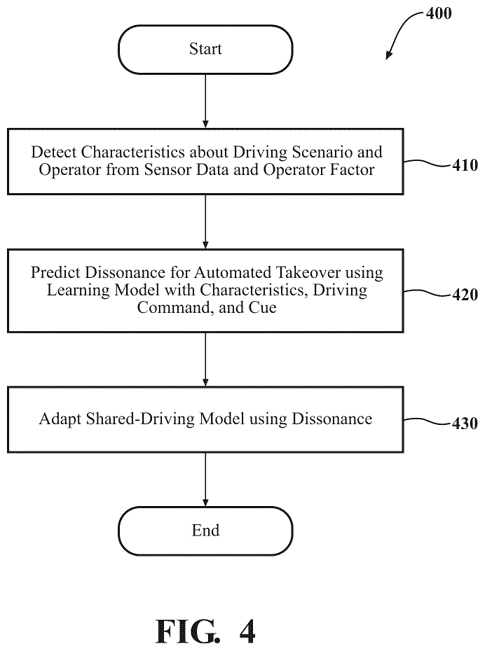

Regarding FIG. 4, one embodiment of a method 400 that is associated with predicting dissonance for an automated takeover using a learning model and adapting a driving model using the dissonance is illustrated. The method 400 will be discussed from the perspective of the prediction system 170 of FIGS. 1 and 2. While the method 400 is discussed in combination with the prediction system 170, it should be appreciated that the method 400 is not limited to being implemented within the prediction system 170 but is instead one example of a system that may implement the method 400.

At 410, the detection module 220 detects characteristics about a driving scenario and an operator and an operator factor from the sensor data 250 and acquired inputs. As previously explained, the driving scenario can be one of passing a vehicle on a highway, crossing an intersection, merging on a highway, parking, etc., or any maneuver that involves shared control. Furthermore, the detected characteristics can describe details about a driving scenario (e.g., crossing an intersection) and an operator. In one approach, the operator factor indicates details about one of a state level for the driving scenario, driving preferences (e.g., cruising speed) associated with the driving scenario, and driver intent associated with a maneuver. Operator factors can include individual factors such as information from a dbq, driving preferences inputted by the operator (e.g., maximum speed, following distance, etc.), executive functioning, cognitive awareness, etc.

Moreover, the acquired inputs can be scenario related to the driving scenario and represent configuration details about an intersection, agents around the vehicle 100 during a highway merge, weather conditions, scene information, etc. Another acquired input can be vehicle interactions derived from one of steering, braking, and throttle information executed by the operator. Thus, the inputs can be data associated with operator feelings about the driving scenario and responsive actions to an automated maneuver.

At 420, the prediction system 170 predicts dissonance for an automated takeover using a learning model with characteristics, a driving command, and a cue. During inference, the prediction system 170 may acquire scenario and vehicle interaction information and feed the information to a shared controller. The vehicle 100 can use outputs from the shared controller for sharing control with an operator in real-time. In one approach, the shared controller is a SDM that outputs an automated takeover having the driving command for a maneuver recommended to the vehicle 100. Although this example involves an SDM navigating the driving scenario, the shared controller can utilize any driving model for shared control of the vehicle 100. Furthermore, the prediction system 170 may feed the operator factor to a dissonance detector rather than the shared controller during inference operation for efficiency through reducing redundant inputs.

Moreover, in one embodiment, the shared controller derives a physical cue and a verbal cue from the sensor data 250 about the driving scenario during shared control. As previously explained, these cues can represent the operator exhibiting an elevated heart rate when fear increases, emotions change, voice tones change, etc. For instance, a physical cue is eye movement from images captured by a vehicle camera for tracking operator views associated with focusing on a road object, looking in the cabin, looking away from a road, hyperfocusing on the road object, etc. In this way, the prediction system 170 can use the information as early indicators to estimate dissonance and increase confidence when combined with the vehicle interactions during a shared maneuver.

In various implementations, outputs from the shared controller can include parameters describing the automated takeover, the physical cue, and the verbal cue that the dissonance detector processes to anticipate dissonance. Here, a learning model of the dissonance detector estimates whether the operator would experience dissonance through factoring the parameters about the automated takeover, the physical cue, the verbal cue, the operator factor, the scenario information, and the vehicle interactions during inference. In this way, the prediction system 170 can accurately infer dissonance using operator factors (e.g., preference, intent, etc.) along with automated tendencies, such as driving commands outputted by the automated driving module(s) 160.

In one embodiment, outputs from the dissonance detector include a score indicating a degree of the dissonance. The score can be one of a numeric value (e.g., 1-10), a numeric value including qualitative metrics such as confidence, etc. Furthermore, the prediction system 170 may compute a decision result indicating one of the operator controlling the vehicle 100 rather than allowing a maneuver involving automated control (e.g., an automated lane change) and the automated takeover of the vehicle 100 by the driving model. Here, the vehicle 100 executes the automated takeover when the decision result indicates no, limited, etc., dissonance by the operator. Otherwise, the shared control involves the operator primarily driving the vehicle 100 upon detecting dissonance. Operator control can be maintaining a mode for shared control that avoids a manual takeover and disabling the mode.

At 430, the prediction system 170 adapts a SDM using the dissonance computed using the dissonance detector. Although this example references an SDM, the shared control can include any driving model such as a MPC system, a data-driven system that is trained, an ADS, and a shared-decision making model. In one approach, the prediction system 170 adapts future behavior of the vehicle 100 and the shared controller using a score outputted by the dissonance detector and the decision result derived from outputs of the dissonance detector. For instance, the prediction system 170 adjusts hyperparameters during inference for an ADS that is data-driven within the shared controller, thereby improving performance through reducing dissonance. This can involve changing hyperparameters, parameters, etc., influencing decisions for trajectory generation and path planning by the shared controller. In one approach, the shared controller uses the score from the dissonance detector for identifying the cue 240 correlated with dissonance, a takeover strategy, etc., that maximizes performance and safety. In another approach, a MPC adjusts parameters and weights in real-time using computations from cost, loss, etc., functions. Therefore, the prediction system 170 improves adoption of shared control during a driving scenario from the driving model through detecting dissonance using a learning model and adapting the driving model with dissonance factors.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in a subset of possible modes.

In one or more embodiments, the vehicle 100 is an automated or autonomous vehicle. As used herein, “autonomous vehicle” refers to a vehicle that is capable of operating in an autonomous mode (e.g., category 5, full automation). “Automated mode” or “autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), an application-specific integrated circuit (ASIC), a microprocessor, etc. The vehicle 100 can include one or more data stores 115 for storing one or more types of data. The data store(s) 115 can include volatile and/or non-volatile memory. Examples of suitable data stores 115 include RAM, flash memory, ROM, programmable read-only memory (PROM), erasable programmable read-only memory (EPROM), electrically erasable programmable read-only memory (EEPROM), registers, magnetic disks, optical disks, and hard drives. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, or hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

One or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, crosswalks, curbs proximate to the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of: radar sensors 123, LIDAR sensors 124, sonar sensors 125, weather sensors, haptic sensors, locational sensors, and/or the one or more cameras 126. In one or more arrangements, the one or more cameras 126 can be high dynamic range (HDR) cameras, stereo, or infrared (IR) cameras.

The vehicle 100 can include an input system 130. An “input system” includes components or arrangement or groups thereof that enable various entities to enter data into a machine. The input system 130 can receive an input from a vehicle occupant. The vehicle 100 can include an output system 135. An “output system” includes one or more components that facilitate presenting data to a vehicle occupant.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Any of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the prediction system 170, and/or the automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the movement of the vehicle 100. The processor(s) 110, the prediction system 170, and/or the automated driving module(s) 160 may control some or all of the vehicle systems 140 and, thus, may be partially or fully autonomous as defined by the society of automotive engineers (SAE) levels 0 to 5.

The processor(s) 110, the prediction system 170, and/or the automated driving module(s) 160 can be operatively connected to communicate with the various vehicle systems 140 and/or individual components thereof. For example, the processor(s) 110, the prediction system 170, and/or the automated driving module(s) 160 can be in communication to send and/or receive information from the various vehicle systems 140 to control the movement of the vehicle 100. The processor(s) 110, the prediction system 170, and/or the automated driving module(s) 160 may control some or all of the vehicle systems 140.

The processor(s) 110, the prediction system 170, and/or the automated driving module(s) 160 may be operable to control the navigation and maneuvering of the vehicle 100 by controlling one or more of the vehicle systems 140 and/or components thereof. For instance, when operating in an autonomous mode, the processor(s) 110, the prediction system 170, and/or the automated driving module(s) 160 can control the direction and/or speed of the vehicle 100. The processor(s) 110, the prediction system 170, and/or the automated driving module(s) 160 can cause the vehicle 100 to accelerate, decelerate, and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be an element or a combination of elements operable to alter one or more of the vehicle systems 140 or components thereof responsive to receiving signals or other inputs from the processor(s) 110 and/or the automated driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial intelligence elements, e.g., neural network, fuzzy logic, or other machine learning algorithms. Furthermore, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the prediction system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A prediction system comprising:
a memory storing instructions that, when executed by a processor, cause the processor to:
detect characteristics about a driving scenario and an operator from acquired sensor data and an operator factor;
predict dissonance for an automated takeover using a learning model with the characteristics, a driving command, and a cue about the operator; and
adapt a shared-driving model (SDM) associated with a vehicle during a maneuver using the dissonance.

2. The prediction system of claim 1, wherein the instructions to predict the dissonance further include instructions to:
derive the cue by the SDM using the sensor data, wherein the cue includes one of a physical cue and a verbal cue associated with the operator for the driving command; and
receive by the learning model the driving command and the cue from the SDM.

3. The prediction system of claim 2, wherein the instructions to derive the cue further include instructions to:
measure one of a pulse and eye movement from the operator associated with focusing on a road object during the driving scenario; and
identify one of a verbal tone and a keyword from the operator during the driving scenario.

4. The prediction system of claim 1, wherein the instructions to adapt the SDM further include instructions to:
receive, a score of the dissonance and a decision result about the dissonance from the learning model, the decision result indicates one of the operator controlling the vehicle without a manual takeover and the automated takeover of the vehicle by the SDM; and
prevent disagreement with additional commands outputted by the SDM adjusting parameters using the score and the decision result, wherein the parameters are one of hyperparameters of an automated driving system (ADS) and weights of a model prediction control (MPC).

5. The prediction system of claim 1, wherein instructions to detect the characteristics further include instructions to:
identify the operator factor from one of a driving questionnaire and a cognitive test that is text-based about the driving scenario, the cognitive test indicating a cognitive load during the driving scenario.

6. The prediction system of claim 1 further including instructions to:
compute a supervised loss that trains the learning model using the characteristics, the driving command, the cue derived from the sensor data, the dissonance associated with the maneuver, and driving data;
calculate an automation loss during training of the SDM using the characteristics, the cue, and a score of the dissonance outputted from the learning model; and
train the SDM using the automation loss.

7. The prediction system of claim 1, wherein the dissonance indicates that the operator will one of disagree with the driving command and counter the driving command, and the driving command is one of a steering command, a braking command, and a throttle command.

8. The prediction system of claim 1, wherein the SDM is one of a model prediction control (MPC) system, a data-driven system that is trained, an automated driving system (ADS), a shared-decision making (SDM) model, and the learning model is a neural network (NN).

9. The prediction system of claim 1, wherein:
the sensor data includes scene information about an environment associated with the vehicle, and the sensor data includes one of steering, braking, and throttle information by the operator; and
the operator factor indicates one of a state level for the driving scenario, driving preferences associated with the driving scenario, and driver intent associated with the maneuver.

10. A non-transitory computer-readable medium comprising:
instructions that when executed by a processor cause the processor to:
detect characteristics about a driving scenario and an operator from acquired sensor data and an operator factor;
predict dissonance for an automated takeover using a learning model with the characteristics, a driving command, and a cue about the operator; and
adapt a shared-driving model (SDM) associated with a vehicle during a maneuver using the dissonance.

11. The non-transitory computer-readable medium of claim 10, wherein the instructions to predict the dissonance further include instructions to:
derive the cue by the SDM using the sensor data, wherein the cue includes one of a physical cue and a verbal cue associated with the operator for the driving command; and
receive by the learning model the driving command and the cue from the SDM.

12. A method comprising:
detecting characteristics about a driving scenario and an operator from acquired sensor data and an operator factor;
predicting dissonance for an automated takeover using a learning model with the characteristics, a driving command, and a cue about the operator; and
adapting a shared-driving model (SDM) associated with a vehicle during a maneuver using the dissonance.

13. The method of claim 12, wherein predicting the dissonance further includes:
deriving the cue by the SDM using the sensor data, wherein the cue includes one of a physical cue and a verbal cue associated with the operator for the driving command; and
receiving by the learning model the driving command and the cue from the SDM.

14. The method of claim 13, wherein deriving the cue further includes:
measuring one of a pulse and eye movement from the operator associated with focusing on a road object during the driving scenario; and
identifying one of a verbal tone and a keyword from the operator during the driving scenario.

15. The method of claim 12, wherein adapting the SDM further includes:
receiving, a score of the dissonance and a decision result about the dissonance from the learning model, the decision result indicates one of the operator controlling the vehicle without a manual takeover and the automated takeover of the vehicle by the SDM; and
preventing disagreement with additional commands outputted by the SDM adjusting parameters using the score and the decision result, wherein the parameters are one hyperparameters of an automated driving system (ADS) and weights of a model prediction control (MPC).

16. The method of claim 12, wherein detecting the characteristics further includes:
identifying the operator factor from one of a driving questionnaire and a cognitive test that is text-based about the driving scenario, the cognitive test indicating a cognitive load during the driving scenario.

17. The method of claim 12 further comprising:
computing a supervised loss that trains the learning model using the characteristics, the driving command, the cue derived from the sensor data, the dissonance associated with the maneuver, and driving data;
calculating an automation loss during training of the SDM using the characteristics, the cue, and a score of the dissonance outputted from the learning model; and
training the SDM using the automation loss.

18. The method of claim 12, wherein the dissonance indicates that the operator will one of disagree with the driving command and counter the driving command, and the driving command is one of a steering command, a braking command, and a throttle command.

19. The method of claim 12, wherein the SDM is one of a model prediction control (MPC) system, a data-driven system that is trained, an automated driving system (ADS), a shared-decision making (SDM) model, and the learning model is a neural network (NN).

20. The method of claim 12, wherein:
the sensor data includes scene information about an environment associated with the vehicle, and the sensor data includes one of steering, braking, and throttle information by the operator; and
the operator factor indicates one of a state level for the driving scenario, driving preferences associated with the driving scenario, and driver intent associated with the maneuver.
